(19) United States
(12) Patent Application Publication
(10) Pub. No.: US 2002/0016840 A1
(43) Pub. Date: Feb. 7, 2002

(54) Applying recursive policy for scoping of administration of policy based networking

(76) Inventors: Shai Herzog, New Rochelle, NY (US); Yaniv Romem, Jerusalem (IL)

Correspondence Address: TESTA, HURWITZ & THIBEAULT, LLP, HIGH STREET TOWER, 125 HIGH STREET, BOSTON, MA, 02110, US

(21) Appl. No.: 09/853,894

(22) Filed: May 11, 2001

Related U.S. Application Data
(60) Provisional application No. 60/203,969, filed on May 12, 2000.

(51) Int. Cl. G06F 15/173; G06F 15/16

(52) U.S. Cl. 709/225; 709/229

(57) ABSTRACT

A network super-administrator can delegate to one or more network sub-administrators a scope of authority to create policy-based rules used to control access and usage of network resources. The super-administrator can define the delegated scope of authority through a set of policy-based rules and can indicate to which sub-administrator the scope of authority is delegated through an identifier associated with the particular sub-administrator.

### CROSS REFERENCE TO RELATED CASE

This claims priority to and the benefit of Provisional U.S. patent application Ser. No. 60/203,969, filed May 12, 2000, the entirety of which is hereby incorporated herein by reference.

### TECHNICAL FIELD

The invention relates generally to computer networking, and more specifically to systems and methods for controlling network resources.

### BACKGROUND INFORMATION

Computer networks and the Internet Protocol (IP) generally handle data packets based on networking criteria located in the packet header, such as protocol number, source/destination addresses, etc. Transport criteria, such as port numbers are also typically used. With respect to packets, network nodes may allow or deny the packets access to network resources, provide preferential treatment of the packets, or provide a lower quality of service, for example. In general, the network may differentiate the quality of service of different packets based on network and transport header information.

Traditional network performance criteria are based on lower level or so-called Network layer criteria such as IP address, port numbers, and protocol number. This criteria in many cases is insufficient in providing business quality and support for converged networks that integrate voice, data, video traffic, etc. The type and quality of service expected from such networks depends on who is generating the traffic (user), the type of traffic being generated (application), as well as other higher layer criteria. For example, the CEO of a company communicating to his executive team using video conferencing requires a different level of service than a summer intern who is browsing the Internet for MP3 files or sending email to friends.

Policy Based Networking (PBN) is an emerging field which attempts to address the problem. It represents a paradigm shift in network management. PBN provides one technique for controlling network operation and influencing the way packets are handled by network nodes based on high layer criteria. In general, with PBN, network administrators first define networking goals (i.e., “network policy”). Those networking goals are then provided to a policy system which automates and translates the policy into a set of lower-level instructions. Network devices understand the instructions, and the specified goals thus can be accomplished. PBN provides an assortment of individual rules, each of which defines a collection of target packets and their associated action or goal. In the CEO example above, the packet collection would be all the packets that are addressed to and from the CEO workstation, as long as they belong to the video conferencing application. The action or goal could be to guarantee those packets some preferential treatment such as a delay no greater than a certain amount, a bandwidth no less than a certain amount, and/or priority higher than some or all other packets.

### SUMMARY OF THE INVENTION

The example discussed above assumes that the policy system receives input from a single administrator. This traditional model avoids problems associated with multiple administrators, such as the simultaneous inputting of policies that over-ride, conflict, or erase each other, by simply allowing only one administrator. A difficulty with such a simplistic model, however, is that in typical larger-scale deployments, it is highly unlikely and undesirable for a sole administrator to be responsible for updating all the policy rules of the entire network. It would be desirable to provide some hierarchical administrative structure in which one or more higher level administrators delegate scopes of authority to one or more subordinate administrators, while maintaining supervisory authority over the subordinate(s).

The invention involves systems and methods for controlling network resources. One aspect of the present invention relates to a method of delegating authority to control network resources. The method comprises providing parameters associated with network resources and creating at least one rule for delegating a scope of authority to create at least one policy-based rule for controlling access and usage of network resources. The at least one rule for delegating comprises at least one of the parameters and an identifier designating to whom the scope of authority is delegated. The at least one policy-based rule comprises at least one of the parameters. In one embodiment, one of the parameters associated with network resources is priority.

In one embodiment, the method further comprises creating at least one other rule for delegating a separate scope of authority to create at least one additional rule for delegating another scope of authority to create at least one other policy-based rule for controlling access and usage of network resources. The at least one other rule for delegating and the at least one additional rule for delegating each comprises at least one of the parameters and an identifier designating to whom the scope of authority is delegated. The at least one other policy-based rule comprises at least one of the parameters. In another embodiment, the scope of authority to create at least one policy-based rule includes a scope of authority to delegate another scope of authority to create at least one other policy-based rule. In one embodiment, this method of delegation results in a hierarchical scope of authority structure where each particular level in the hierarchy has a scope of authority less than or equal to the level above and a scope of authority greater than or equal to the level below.

Another aspect of the invention relates to a method of controlling network performance. The method comprises providing parameters associated with network resources and creating at least one rule for delegating a scope of authority to create at least one policy-based rule for controlling access and usage of network resources. The at least one rule for delegating comprises at least one of the parameters and an identifier designating to whom the scope of authority is delegated. The at least one policy-based rule comprising at least one of the parameters. The method also comprises determining if a created one of the policy-based rules is within the delegated scope of authority and modifying the created one of the policy-based rules if the created one of the policy-based rules is not within the delegated scope of authority such that the created one of the policy-based rules becomes within the delegated scope of authority. In one embodiment, modifying the created one of the policy-based rules includes ignoring the created one of the policy-based rules not within the delegated scope of authority. In another embodiment, modifying the created one of the policy-based rules includes ignoring a portion of the created one of the policy-based rules not within the delegated scope of authority.

In another embodiment, the method further comprises creating at least one other rule for delegating a separate scope of authority to create at least one additional rule for delegating another scope of authority to create at least one other policy-based rule for controlling access and usage of network resources. The at least one other rule for delegating and the at least one additional rule for delegating each comprises at least one of the parameters and an identifier designating to whom the scope of authority is delegated. The at least one other policy-based rule comprises at least one of the parameters. In still another embodiment, the scope of authority to create at least one policy based rule includes a scope of authority to delegate another scope of authority to create at least one other policy-based rule. In another embodiment, one of the parameters associated with network resources is priority.

Still another aspect of the present invention relates to a system for controlling network performance. The system comprises a module for providing parameters associated with network resources and a module for creating at least one rule for delegating a scope of authority to create at least one policy-based rule for controlling access and usage of network resources. The at least one rule for delegating comprises at least one of the parameters and an identifier designating to whom the scope of authority is delegated. The at least one policy-based rule comprises at least on of the parameters. The system also comprises a module for determining if a created one of the policy-based rules is within the delegated scope of authority and a module for modifying the created one of the policy-based rules if the created one of the policy based rules is not within the delegated scope of authority such that the created one of the policy-based rules becomes within the delegated scope of authority.

In one embodiment, the module for modifying the created one of the policy-based rules modifies the created one of the policy-based rules by ignoring the created one of the policy-based rules if the created one of the policy-based rules is not within the delegated scope of authority. In another embodiment, the module for modifying the created one of the policy-based rules modifies the created one of the policy-based rules by ignoring a portion of the created one of the policy-based rules not within the delegated scope of authority.

In another embodiment, the system further comprising a module for creating at least one other rule for delegating a separate scope of authority to create at least one additional rule for delegating another scope of authority to create at least one other policy-based rule for controlling access and usage of network resources. The at least one other rule for delegating and the at least one additional rule for delegating each comprises at least one of the parameters and an identifier designating to whom the scope of authority is delegated. The at least one other policy-based rule comprises at least one of the parameters. In another embodiment, the scope of authority for creating a policy-based rule includes a scope of authority to delegate another scope of authority to create at least one other policy-based rule. In still another embodiment, one of the parameters associated with network resources is priority.

It is one general object of the invention to apply Meta Policy Scoping (MPS) to Policy Based Networking (PBN) in order to create and maintain hierarchical delegation of authorization for policy rule creation. It is another general object of the invention to allow MPS and PBN to use the same policy structure and syntax with the exception that MPS has at least one additional criteria (such as AdminID (author)) to designate the lower level administrator to which the delegation is made. It is a further general object of the invention to allow MPS and PBN to share basic properties of scalability, flexibility, redundancy, fail-over, etc., such that a similar policy system may process both with minimal overhead and code needed to add MPS to an existing PBN system. Another general object of the invention is to allow the MPS operation logic (e.g., validation and reduction) to either implement strict authorization (e.g., block rules that exceed authorization) or implement flexible authorization (e.g., implicitly restrict and/or amend out-of-authorization rules to fit within the authorization). Still another general object of the invention is to allow MPS cascaded delegation such that a policy rule is scoped by a series of hierarchical MPS rules.

In general, the invention relates to allowing a plurality of administrators to control the behavior of a network. After a set of policy-base rules to control network policy is established, a subset of the set of policy-based rules is delegated to each of the administrators. Each administrator can then set network policy according to the subset delegated to that particular administrator.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustrative embodiment of an implementation of a system for controlling network resources.

FIG. 2 illustrates a hierarchical delegation of diminishing scope.

FIG. 3 illustrates a hierarchical delegation tree with three administrators according to an embodiment of the invention.

FIG. 4 illustrates a hierarchical delegation network according to another embodiment of the invention.

### DESCRIPTION

The invention relates to systems and methods for controlling network resources. A network super-administrator delegates to one or more network sub-administrators a scope of authority to create policy-based rules used to control access and usage of network resources. The super-administrator defines the delegated scope of authority through a set of policy-based rules (policy) and indicates to which sub-administrator the scope of authority is delegated through an identifier associated with the particular sub-administrator.

The process of delegating a scope of authority to control access and usage of network resources is called administrative scoping. There are different methods for administrative scoping. As an example, authority could be delegated to sub-administrators based on specific network regions. Authority could also be delegated based on a set of policy-servers, a set of network nodes, or a set of interfaces, for example. This type of administrative scoping is static because it is based on pre-defined lists (of nodes, policy-servers, etc.), and therefore, lacks the flexibility necessary to address dynamically changing network topology and usage. For example, lists can become inaccurate or incomplete when interfaces or nodes are added, removed, or change their identification or physical characteristics. Furthermore, static administrative scoping directly contradicts the notions of redundancy (multiple policy servers) and fail-over in large networks (moving control from one policy server to another policy server when the first policy server fails). For instance, when a network failure occurs, numerous automatic backup facilities are typically invoked. These automatic backup facilities generally are dynamic and unpredictable, and therefore, pose problems for maintaining such rigidly defined administrative scoping.

Another method for administrative scoping is through Policy-based Networking. PBN provides a technique for controlling network operation and influencing the way data packets are handled by network nodes (some data packets are given priority of other data packets, for example). Network administrators first define networking goals or actions which is referred to as network policy. A policy is a formal set of statements that define how the network's resources are allocated among the network's clients (e.g. computer systems connected to the network). The network policy is integrated with a policy system which automates and translates the policy rules into a set of lower-level instructions that network devices understand. Policy Based Networking (PBN) enables dynamic binding between a collection of data packets and associated actions. This means that the link between the collection of data packets and the associated actions adapts to the current conditions of the network, and therefore avoids the complications of rigid network configurations. For example, an action (or rule) giving high priority to network data associated with the CEO of a company has the same effect on the network regardless of the topography of the network. (number of nodes, interfaces, servers, regions at any given time). In contrast, rules defined in rigid network configurations (where sub-administrators have authority based on specific network regions, specific set of policy-servers, specific set of network nodes, or specific set of interfaces, for example) affect only the configuration in which they were defined. If additional network regions, policy-servers, nodes, or interfaces are added, the rules controlling the network must be re-defined to include the new additions.

In one embodiment of the invention, the PBN mechanism can be applied to scope itself. In other words, policy-based rules can be used to define the limits of administrators' authority to define policy-based rules used to control network resources. The invention uses the principles of PBN theory to create a meta-policy that applies in a recursive process to form self-scoping and hierarchical management of policy rule administration. This self-scoping and hierarchical management of policy rule administration is called Meta-Policy Scoping (MPS).

Meta-Policy Scoping (MPS) according to the invention has advantages over known hierarchical methods of administrative scoping. Both Policy and Meta Policy use the same language syntax and usage rules allowing operations such as validation (that is, checking if a certain rule is within the authorized scope of authority) and reduction (that is, editing a policy rule so that it is within the authorized scope of authority) to be easily performed. Cascading (that is, progressively narrower) scopes and reduction rules have a property of “inheritance” whereby a change to a higher-level scope (such as an expansion or restriction) will automatically affect all the lower level scopes and reduced rules. As an example, assume a super-administrator delegates to a sub-administrator the authority to give network data to a CEO a high priority. Also assume, that the sub-administrator further delegated this same authority to other sub-administrators. If at a later time the super-administrator takes away this authority from the sub-administrator, the authority delegated by the sub-administer to other sub-administers is also automatically taken away.

Policy and meta-policy using the same language reduces the code size and complexity for adding meta-policy to an existing PBN system. Furthermore, the complexity and learning curve is reduced for administrators using the system who already know how to define policies.

Furthermore, since both PBN and MPS use similar mechanisms, PBN and MPS also share certain procedures for adapting to dynamic changes such that policy rules and meta-policy rules remain synchronized. Both PBN and MPS also share certain procedures for supporting system redundancy and supporting fail-over.

One embodiment of MPS reuses the PBN mechanism itself in a recursive manner to implement administrative scoping. This means that similar policy structure, syntax, and operations can be used to control both the administrative scoping (through meta-policy rules) as well as the actual network service (through standard policy-based rules). Meta-policy rules differ in representation from standard policy rules in that they include an “AdminID=” clause which identifies to whom (which administrator) the scope of authority is delegated.

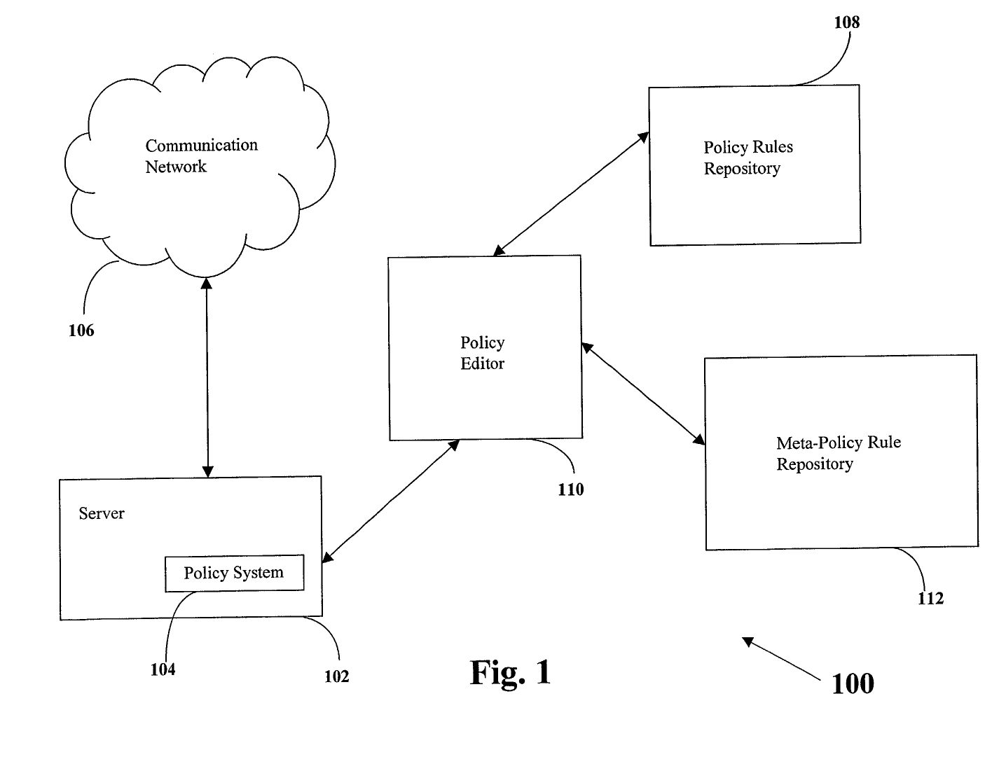

Turning now to the drawings, FIG. 1 is an illustrative embodiment of an implementation of a system 100 for controlling network resources, according to the invention. The system 100 includes a server computer system 102, a policy system 104, a policy editor 110, a policy rule repository 108, a meta-policy rule repository 112, and a communication network 106. The server 102 is in communication with the network 106 such that the server can communicate with any other devices also connected to the network 106. The policy system 104 typically resides on the server 102 and, as mentioned above, automates and translates the policy rules into a set of lower-level instructions that network devices understand. The server 102 is also in communication with the policy editor 110. The policy editor 110 is used to create new policy and meta-policy rules and edit existing policy and meta-policy rules. The policy editor 110 can reside locally on the server 102 or can be located remotely. The policy editor 110 is also in communication with the policy rule repository 108 and the meta-policy rule repository 112. The policy rule repository 108 is used for storing policy rules and the meta-policy rule repository 112 is used for storing meta-policy rules. Both repositories 108, 112 can reside locally on the server 102 or can be located remotely.

In one embodiment, system administrators use the policy editor 110 to create new policy rules and meta-policy rules or edit existing policy rules and meta-policy rules. The newly created or edited policy rules are then stored in the policy rule repository 108 and the meta-policy rule repository 112 respectively. The policy system 104 uses the policy rules stored in the policy rule repository 108 to control network 106 resources and the meta-policy rules stored in the meta-policy rule repository 112 to ensure that the policy rules in the policy rule repository 108 are properly defined (e.g. that each policy rule defined by an administrator is within that administrator's scope of authority).

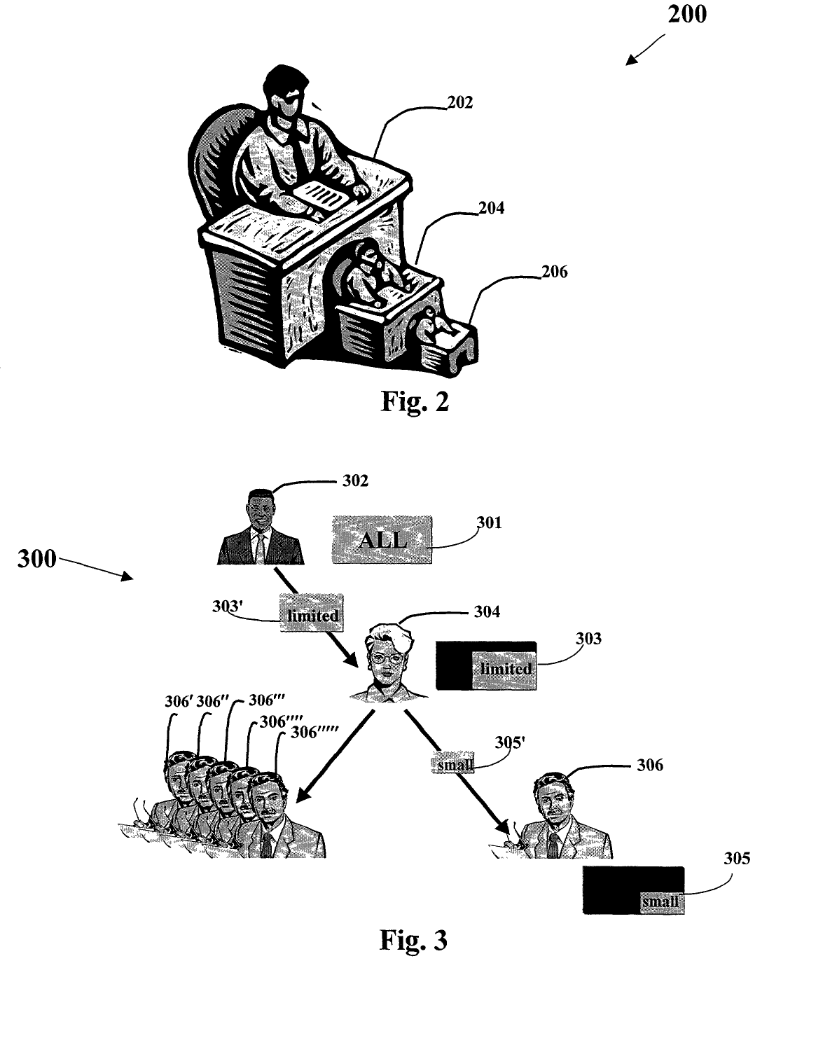

FIG. 2 illustrates a hierarchical delegation of diminishing scope 200. In this example, the super-administrator 202 has the highest authority and has the authority to delegate some or all authority to a sub-administrator 204. The super-administrator 202 cannot delegate any authority to the sub-administrator 204 that is outside the super-administrator's 202 scope of authority. Further, the sub-administrator 204 has the authority to delegate to another sub-administrator 206 some or all of the authority the sub-administrator 204 has. The sub-administrator 204 cannot delegate any authority to the sub-administrator 206 that is outside the sub-administrator's 204 scope of authority. In general, administrators can provide any subset of their own scope, but administrators cannot delegate authority that this beyond their scope of authority.

FIG. 3 illustrates a hierarchical delegation tree 300 with super-administrator 302, sub-administrator 304, and sub-administrators 306 to 306′″″. The super-administrator 302 has authority 301 over the entire network, the sub-administrator 304 has only that authority 303, 303′ that is delegated by the super-administrator 302, and the sub-administrator 306 has only that authority 305, 305′ that is delegated by the sub-administrator 304. The sub-administrator 304 cannot delegate more authority than the sub-administrator 304 has, therefore the sub-administrator 306 is delegated authority 305 over a cascading delegation (super-administrator 302≧sub-administrator 304≧sub-administrator 306).

The following rule set provides an example of an administrative scope delegation between a top-level such as the super-administrator 302 and a mid-level such as the sub-administrator 304. In the example below, the super-administrator 302 has authority 301 over every possible policy rule in the network. Assume the super-administrator 302 wishes to provide the sub-administrator 304 with a limited capability to define and/or modify policy rules by delegating authority 303′. When there is a plurality of administrators, each meta-policy rule must be created and associated with an “owner” (the person to whom the authority is delegated). In one embodiment, the association is part of the rule. In another embodiment, the association is an attribute or function of a policy rule set (e.g. author( )).

As an example of a policy rule that authorizes the assignment of high-priority to a video session of a CEO, consider the following.

If ((Application=Video) and (UserID=CEO) and (Time-of-Day=(10 am-11 pm)))

Then Priority=High

Assuming that the super-administrator 302 wishes to delegate authority 303′ to a sub-administrator 304, the super-administrator 302 can define a meta-policy rule such as:

If ((AdminID=“Sub-administrator 304”) and (Application=(Video or Audio)))

Then Priority=(Medium, Low, Lowest)

The above rule authorizes the sub-administrator 304 to define rules that apply to applications that are either Video or Audio and allocate to those applications Medium, Low, or Lowest priority. This delegation indicates that if the Video application requires “High” priority, the sub-administrator 304 would be administratively prohibited from defining rules for the Video application. Conversely, the super-administrator 302 is allowed to define rules for the Video application, because the super-administrator 302 has the required authority.

As another example, assume super-administrator 302 defines a different rule as follows:

If ((AdminID=“Sub-administrator 304”) and (Time-of-Day=(9 am-12 pm)))

Then Priority=High

The sub-administrator 304 is delegated additional authority to provide any traffic with “High” priority as long as it is between the hours of 9 am and 12 pm. The sub-administrator 304, in this case, is authorized to give the “High” priority rule to the CEO's video traffic in the form of the following rule:

If ((Application=Video) and (UserID=CEO) and (Time-of-Day=(10 am-11 am)))

Then Priority=High

In another embodiment, the invention addresses situations in which administrators define rules outside the scope of the administrator's authority. Consider the following example where the sub-administrator 304 defines a rule which omits the time of day restriction imposed by the super-administrator 302.

If ((Application=Video) and (UserID=CEO))

Then Priority=High

In one embodiment, the above rule, which is outside the scope of authority 303 of the sub-administrator 304, can be handled in at least two ways. In one embodiment, the policy system 104 informs the sub-administrator 304 that the rule is in error because the rule applies “High” priority at any time during the day while the sub-administrator 304 is administratively restricted to providing “High” priority only between the hours of 9 am and 12 pm. In this case, the rule is not implemented. In another embodiment, the policy system 104 informs the sub-administrator 304 that the rule is beyond the scope of the sub-administrator's 304 authority but that the rule is accepted by the policy system 104 as written. However, the sub-administrator's 304 administrative scope of authority 303 is considered to be implicit in the rule and the rule is interpreted by the system as if the time-of-day restriction had been included, as shown below.

If ((Application=Video) and (UserID=CEO) and (Time-of-Day=(9 am-12 pm)))

Then Priority=High

The second option is referred to as reduction and is more flexible, but the implicit nature of the restrictions can make the rule less predictable, since the meaning of a well-known set of rules may change due to a change of the scope relating sub-administrator 304.

The sub-administrator 304 also has the capability of delegating all or a subset of the sub-administrator's 304 authority 303 to a lower-level such as sub-administrator 306. For example, the sub-administrator 304 may define the following rule.

If ((AdminID=“Sub-administrator 206”) and (Application=Video) and (UserD=CEO) and (Time-of-Day=(10 am-11 am)))

Then Priority=(low, lowest)

The above rule authorizes the sub-administrator 306 to define rules that apply to applications that are Video only and allocate to those applications Low or Lowest priority as long as the allocation is between 10 am and 11 am. This delegation indicates that if the Video application requires “High” or “Medium” priority, sub-administrator 306 would be administratively prohibited from defining rules for the Video application.

As another example, assume the sub-administrator 304 defines the following rule.

If (AdminID=“Sub-administrator 306”)

Then Priority=High The above rule exceeds the administrative scope of authority 303 of the sub-administrator 304 because the sub-administrator 304 is only authorized to allocate “High” priority between the hours of 9 am and 12 pm for Video or Audio applications when the UserId=CEO. There are at least two possible ways the above out-of-scope rule can be handled. In one embodiment, the sub-administrator 304 is informed by the policy system 104 that the out-of-scope rule is in error because the rule applies “High” priority at any time during the day, for any application, and for any UserId. The sub-administrator 304 is administratively restricted to provide “High” priority only between the hours of 9 am and 12 pm for Video or Audio applications and only for UserId=CEO. In this case the rule is not implemented. In another embodiment, the sub-administrator 304 is informed that the rule is beyond the scope of the sub-administrator's 304 authority 303 but that the rule is accepted by the policy system 104 as written. However, the sub-administrator's 304 administrative scope of authority 303 is considered to be implicit in the rule and the rule is interpreted by the policy system 104 as if the time-of-day, application, and UserId restrictions had been included, as shown below.

If ((AdminID=“Sub-administrator 306”) and (Application=Video) and (UserID=CEO) and (Time-of-Day=(9 am-12 pm)))

Then Priority=High

Referring again to FIG. 3 and the meta-policy rule above, two Administrative scopes of authority apply to the sub-administrator 306. The sub-administrator 306 is restricted by the scope delegated by the sub-administrator 304 and also by the scope of delegated to the sub-administrator 304. This is because the sub-administrator 304 cannot delegate authority beyond that which was delegated by the super-administrator 302. Thus, the combined cascading scope of authority 305 that applies to the sub-administrator 306 would be adjusted in its Time-of-Day to comply with the sub-administrator's 304 authorized administrative scope.

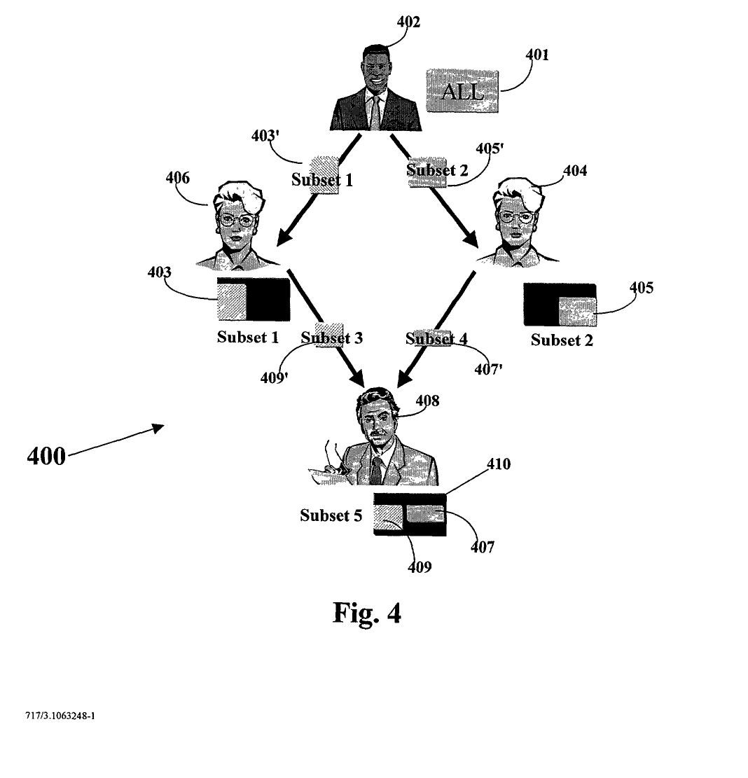

FIG. 4 illustrates a hierarchical delegation network (mesh) 400 with four administrators including super-administrator 402, sub-administrator 404, sub-administrator 406, and sub-administrator 408. The super-administrator 402 has authority 401 over the entire network. The sub-administrator 406 only has authority 403′, 403 that is delegated by the super-administrator 402, and the sub-administrator 404 only has authority 405′, 405 that is delegated by the super-administrator 402. The sub-administrator 408 has the combined authority 410 that is delegated by the sub-administrator 404 and the sub-administrator 406, specifically authority 409′, 409 is delegated from the sub-administrator 406 and authority 407′, 407 is delegated from the sub-administrator 404. Unlike the tree embodiment shown in FIG. 3, this embodiment supports a non-tree structure with multiple administrators 404, 406 delegating combined authority 410 to a single subordinate administrator 408. As a result, the sub-administrator 408 can define policy rules that cannot be defined by either the sub-administrator 404 or the sub-administrator 406 alone but only by combining the scope of authority 405 of the sub-administrator 404 and the scope of authority 403 of the sub-administrator 406.

Referring again to FIG. 4, the following rule set provides an example of an administrative scope delegation between a top-level super-administrator 402 and two mid-level sub-administrators 404 and 406. In this example, the super-administrator 402 has authority 401 over every possible policy rule in the network. Assuming that the super-administrator 402 wishes to delegate authority 403′ to the sub-administrator 404 and authority 405′ to sub-administrator 406, the super-administrator 402 can define meta-policy rules shown below.

If ((AdminID=sub-administrator 404) and (Application=Video))

Then Priority=(Medium, Low)

If ((AdminID=sub-administrator 406) and (Application=Audio))

Then Priority=(High, Medium)

If ((AdminID=sub-administrator 408) and (Time-of-Day=(9 am-3 pm)))

Then Priority=Medium

If ((AdminID=sub-administrator 408) and (Time-of-Day=(11 am-5 pm)))

Then Priority=Medium

Based on the above delegations, the sub-administrator 408 can define the following rule that could have not been authored by either the sub-administrator 404 or the sub-administrator 406 alone.

If ((Time-of-Day=(1 am-3 pm)) and (Application=(Audio or Video)))

Then Priority=Medium

Another embodiment of the invention relates to the type of policy delegation. In this embodiment, rather than delegating a single scope of authority, each administrator may delegate two scopes of authority referred to as policy-creation scope and policy-delegation scope. The policy-creation scope authorizes a lower level administrator to create policy rules, while the policy-delegation scope authorizes the lower-level administrator to create meta-policy (and thus continue the delegation by delegating a scope of authority to another sub-administrator). For example, the sub-administrator 404 may authorize the sub-administrator 408 to create policies with mid-level priority, but restrict the sub-administrator's 408 ability to further delegate to others to low-level priority only. The first embodiment assumes that both the policy-creation and delegation scopes are the same (thus an administrator is authorized to create policy and/or delegate the same set of policies). This embodiment allows the separation of these scopes of authority. As another example, the super-administrator 402 may authorize the sub-administrator 406 to create policy rules only. In this case the sub-administrator 406 has non-delegable scope. The super-administrator 402 has delegated the authority to the sub-administrator 406 to create policy rules, but not the authority to delegate any part of that authority to the sub-administrator 408, for example.

In another illustrative embodiment, the super-administrator 402 could authorize the sub-administrator 406 to delegate a portion of the sub-administrator's 406 scope. In this embodiment, policy-creation scope and policy-delegation scope are handled independently as if each has a single scope with the exception that any policy-delegation authorization implies policy-creation authorization (but not the reverse, meaning that a policy-creation authorization does not imply any policy-delegation authorization).

In one embodiment, one method of formally describing Meta Policy Scoping (MPS) logic can be achieved through the use of the following definitions.

Policy Domain: a policy domain D is defined as a vector (with finite or infinite length) of heterogeneous sets D(i). (Each set D(i) represent a possible policy rule template (without values))

Policy Rule Instance: a policy rule instance pr(i) over D(i) is defined as a value assignment for the set D(i). (Each instance pr(z) represents a possible value assignment for rule template D(i).)

Policy: a policy P over domain D is a set pr of policy rule instances from domain D authored by A such that author(P)=A and instances(P)=pr.

For example, a policy P authored by sub-administrator 408 comprising a single rule, “if (UserGroup=TopExecutives) then (Priority=Low)”, is represented as: A=“sub-administrator 408” and pr comprises of one instance pr(i)=<TopExecutives, Low>, which is a subset of the set of all the instances of set D(i)=<UserGroup, Priority> in domain D. (NOTE: policy is always per single author).

Meta Domain: a meta domain MD is defined over domain D such that it comprises of <“Author”, s(1), s(2), . . . >for every D(i)=<s(1), s(2), . . . >in D. It is always true that domain(MD)=D (NOTE: an Author identification is prefixed to each rule template D(i)). Meta Policy: a meta policy MP over domain MD is a set mpr of meta-policy rule instances from domain MD authored by A such that author(MP)=A and instances(MP)=mpr. Policy and

Meta Policy Relationship: given policy P over domain D and MP over domain MD such that domain(MD)=D, it is true that MP=Meta(P) if for every instance pr(i)=<s(1),s(2), . . . >in instances(P) there is an instance <author(P),s(1),s(2), . . . >in instances(MP) and vice versa.

The following operations can be done on Policy and Meta-Policy to determine and adjust authorization of policy rule creation.

Policy Validation: verify that policy P complies with administrative scope MP: a policy P is considered to be validated by a meta-policy MP if for every instance pr(i)=<s(1),s(2), . . . >in instances(P) there is an instance <author(P),s(1),s(2), . . . >in instances(MP)

Policy Reduction: amend policy P into P′ that is compliant with administrative scope MP: a policy reduction P′=reduct(P,MP) if author(P)=author(P′) and instances(P′) include all pr(i)=<s(1),s(2), . . . >from instances(P) such that instance <author(P),s(1),s(2), . . . >is in instances(MP)

Cascading (Meta) Policy Reduction: amend an administrative scope MP1 into MP′ that is compliant with an established previous-level administrative scope MP2. A policy reduction MP′=reduct(MP1,MP2) if author(MP1)=author(MP′) and instances(MP′) include all mpr(i)=<A, s(1), s(2), . . . >from instances(MP1) such that instance <author(MP1),s(1),s(2), . . . >is in instances(MP2), and A is any other author (not author(MP1) or author(MP2)).

Cascading Policy Validation: merge multiple levels of administrative scopes (MP1 . . . MPn) into one equivalent meta-policy scope MP′. Consider a set of cascading meta-policies MP1 . . . MPn such that MPn is scoping MPn-1 and MPn-1 is scoping MPn-2, . . . until MP1. A policy P is considered to be validated by a set of cascading meta-policies MP1 . . . MPn if for every instance pr(i)=<s(1),s(2), . . . >in instances(P) there is an instance <author(P),s(1),s(2), . . . >in MP′=reduct( . . . reduct(reduct(MPn, PMn-1), PMn-2), . . . PM1).

The above definitions allow administrative dissemination of policy definitions such that top layer administrators can write meta-policy that is used either to validate or to reduce policy written by subordinates.

Variations, modifications, and other implementations of what is described herein will occur to those of ordinary skill in the art without departing from the spirit and the scope of the invention. Accordingly, the invention is not to be defined solely by the preceding illustrative description.

What is claimed is:

1. A method of delegating authority to control network resources, comprising:
(a) providing parameters associated with network resources; and
(b) creating at least one rule for delegating a scope of authority to create at least one policy-based rule for controlling access and usage of network resources, the at least one rule for delegating comprising at least one of the parameters and an identifier designating to whom the scope of authority is delegated, the at least one policy-based rule comprising at least one of the parameters.

2. The method of claim 1 further comprising creating at least one other rule for delegating a separate scope of authority to create at least one additional rule for delegating another scope of authority to create at least one other policy-based rule for controlling access and usage of network resources, the at least one other rule for delegating and the at least one additional rule for delegating each comprising at least one of the parameters and an identifier designating to whom the scope of authority is delegated, the at least one other policy-based rule comprising at least one of the parameters.

3. The method of claim 1 wherein the scope of authority in step (b) includes a scope of authority to delegate another scope of authority to create at least one other policy-based rule.

4. The method of claim 1 wherein step (a) comprises providing priority as one of the parameters.

5. A method of controlling network performance, comprising:
(a) providing parameters associated with network resources;
(b) creating at least one rule for delegating a scope of authority to create at least one policy-based rule for controlling access and usage of network resources, the at least one rule for delegating comprising at least one of the parameters and an identifier designating to whom the scope of authority is delegated, the at least one policy-based rule comprising at least one of the parameters;
(c) determining if a created one of the policy-based rules is within the delegated scope of authority; and
(d) modifying the created one of the policy-based rules if the created one of the policy-based rules is not within the delegated scope of authority such that the created one of the policy-based rules becomes within the delegated scope of authority.

6. The method of claim 5 wherein step (d) comprises ignoring the created one of the policy-based rules not within the delegated scope of authority.

7. The method of claim 5 wherein step (d) comprises ignoring a portion of the created one of the policy-based rules not within the delegated scope of authority.

8. The method of claim 5 further comprising creating at least one other rule for delegating a separate scope of authority to create at least one additional rule for delegating another scope of authority to create at least one other policy-based rule for controlling access and usage of network resources, the at least one other rule for delegating and the at least one additional rule for delegating each comprising at least one of the parameters and an identifier designating to whom the scope of authority is delegated, the at least one other policy-based rule comprising at least one of the parameters.

9. The method of claim 5 wherein the scope of authority in step (b) includes a scope of authority to delegate another scope of authority to create at least one other policy-based rule.

10. The method of claim 5 wherein step (a) comprises providing priority as one of the parameters.

11. A system for controlling network performance, comprising:
(a) a module for providing parameters associated with network resources;
(b) a module for creating at least one rule for delegating a scope of authority to create at least one policy-based rule for controlling access and usage of network resources, the at least one rule for delegating comprising at least one of the parameters and an identifier designating to whom the scope of authority is delegated, the at least one policy-based rule comprising at least on of the parameters;
(c) a module for determining if a created one of the policy-based rules is within the delegated scope of authority; and
(d) a module for modifying the created one of the policy-based rules if the created one of the policy based rules is not within the delegated scope of authority such that the created one of the policy-based rules becomes within the delegated scope of authority.

12. The system of claim 11 wherein the module for modifying the created one of the policy-based rules modifies the created one of the policy-based rules by ignoring the created one of the policy-based rules if the created one of the policy-based rules is not within the delegated scope of authority.

13. The system of claim 11 wherein the module for modifying the created one of the policy-based rules modifies the created one of the policy-based rules by ignoring a portion of the created one of the policy-based rules not within the delegated scope of authority.

14. The system of claim 11 further comprising a module for creating at least one other rule for delegating a separate scope of authority to create at least one additional rule for delegating another scope of authority to create at least one other policy-based rule for controlling access and usage of network resources, the at least one other rule for delegating and the at least one additional rule for delegating each comprising at least one of the parameters and an identifier designating to whom the scope of authority is delegated, the at least one other policy-based rule comprising at least one of the parameters.

15. The system of claim 11 wherein the scope of authority includes a scope of authority to delegate another scope of authority to create at least one other policy-based rule.

16. The system of claim 11 wherein the parameters associated with network resources include at least priority.
